(19) United States
(12) Patent Application Publication
(10) Pub. No.: US 2014/0005860 A1
(43) Pub. Date: Jan. 2, 2014

(54) Wirelessly Controlled Vehicle Message System

(71) Applicant: Marion Chance, Church Hill, MD (US)

(72) Inventor: Marion Chance, Church Hill, MD (US)

(21) Appl. No.: 13/913,873

(22) Filed: Jun. 10, 2013

Related U.S. Application Data
(60) Provisional application No. 61/665,608, filed on Jun. 28, 2012.

(51) Int. Cl. B60Q 1/26

(52) U.S. Cl. CPC B60Q 1/2615
USPC 701/2

(57) ABSTRACT

A digital vanity display system for a motor vehicle is presented, whereby a digital screen is connectable to the interior or exterior of the vehicle and a given message or symbol can be displayed therefrom via the driver or passenger's wireless input thereto. The display device includes a digital display having an antiglare coating for clarity, along with a display body for housing the system elements that allow for the sign operation, wireless communications, and power. A handheld device within the vehicle, such as a phone or tablet, is wirelessly paired to the display system such that inputs from the user can be wirelessly communicated thereto to update the sign. It is contemplated that the sign function as a vehicle personalization device, a messaging system for nearby motorists, a warning sign, and a traffic signal between vehicles.

### CROSS REFERENCE TO RELATED APPLICATION

This application claims the benefit of U.S. Provisional Application No. 61/665,608 filed on Jun. 28, 2012, entitled “Expressions.” The above identified patent application is herein incorporated by reference in its entirety to provide continuity of disclosure.

### BACKGROUND OF THE INVENTION

1. Field of the Invention

The present invention relates to automotive communication devices and signs for automotive use. More particularly, the present invention pertains to a vehicle-mounted sign or vanity display for signaling and communicating with nearby motorists using a digital display, whereby the display is controlled by a wireless device within the vehicle interior and can be updated by a user while the car is in operation.

Personalizing a motor vehicle is a common activity for many individuals, particularly those that wish to express themselves and distinguish their vehicle from others on the road. Some motorists desire to display messages to other motorists or express their views in some form or fashion. Generally this is accomplished by way of external vehicle modifications or through the use of stickers or magnets. Vehicle modifications, such as updates and changes to the structure of the wheels and body panels, can be very expensive and generally are permanent to semi-permanent changes. External stickers and magnets, however, are temporary signs that can be readily removed and replaced as the user's tastes and his or her desired message changes.

Bumper stickers and magnets generally attach to the exterior pain or window surfaces of the vehicle, whereby one surface provides connection to the vehicle while the opposite surface provides a placard or message for others to visualize when passing by the vehicle. It is not uncommon to find bumper stickers for specific events or for specific activities, such as messages to support an elected official, support a favorite activity or vacation destination, or further to provide a motivational or political message to passersby.

The primary drawback to such devices is their limited ability to be updated. While these devices can be peeled and detached from the vehicle exterior, this requires the user to be outside of the vehicle and is generally done after long periods of time between updates. These signs are also static messages that cannot be updated on the fly to give updated messages or warnings to nearby motorists. To fulfill this need, a digital sign or “bumper sticker” is desired, whereby the message can be readily updated based on input from the user. The use of a digital screen allows for a display area that can be readily updated with a message without requiring the user to replace the sign to update an outgoing message. In this way, the sign is a more active message device and one that accepts real-time updates.

The present invention provides such a device to fulfill this need, whereby an attachable digital display is provided having a wireless capability and an internal power supply. The device can be paired to a handheld device, such as a smartphone or tablet, whereafter the user of the handheld device can affect changes to the digital display to update the display message or to display a desired image. The device is attachable to a vehicle exterior or to the interior window of the vehicle, whereby the digital display faces outward to other motorists. Contemplated uses include providing a personalized and readily updatable screen that replaces static bumper stickers, along with a means to warn to communicate to other motorists in a real-time fashion (e.g. emergency events, traffic conditions, notices of “baby on board”, funeral processions, etc.).

In today's modern, interconnected society where instantaneous updates are desired and a majority of society is connected through various mediums, the present invention provides yet another advancement that allows for real-time updates and messaging to others while on the road and within a motor vehicle. The user's mood, a personalized message, or a particular notice to nearby motorists can be displayed from the updatable digital display. The user within the vehicle pairs with or otherwise communicates the message to the digital display to control its behavior and operation, while the device operates from its own power source.

2. Description of the Prior Art

Devices have been disclosed in the prior art that relate to vanity plates and digital message displays for vehicles. These include devices that have been patented and published in patent application publications. The following is a list of devices deemed most relevant to the present disclosure, which are herein described for the purposes of highlighting and differentiating the unique aspects of the present invention, and further highlighting the drawbacks existing in the prior art.

Specifically, U.S. Patent Application Publication No. 2006/0059745 to Maqui discloses a digital message and display device for use on a vehicle, wherein the device includes memory storage, a central processing unit, a power source, and a keypad data input mechanism for updating the display message. Along with the keyboard, the Maqui device contemplates a voice recognition system for voice-inputting a message, and finally a signal receiver for detecting and receiving electronic signals transmitted via satellite. While providing a means of updating a digital display for a vehicle, the Maqui device fails to describe one that includes direct communication to a handheld device within the vehicle, and most notably for a smartphone or tablet device that can pair with the message system. The present invention is adapted to connect by way of short range wireless connection, wherein text or visual messages can be relayed from the handheld device while the display is in operation.

U.S. Patent Application Publication No. 2011/0013109 to Bryan discloses a solar powered, window-mountable vehicle display that includes a digital display screen, control circuitry, and a solar powered battery pack. The device secures to the window of a vehicle along the interior surface by way of suction cups or hook and loop fasteners, wherein an operating system stored within the memory of the device allows for the user to choose the given message or display. The Bryan device, while providing a message display for a motor vehicle, fails to disclose the wireless communication capability of the present invention. The present invention is further powered by a conventional battery pack.

Finally, U.S. Patent Application Publication No. 2003/0034934 and 2002/0121970 to Brewer discloses a vanity display device that allows for a customizable message to be displayed using a display composition computer within the vehicle. While disclosing a digital vanity display having similar elements, the Brewer devices fail to disclose all elements of the present invention. The Brewer device contemplates an electronic display composition computer for constructing messages and relaying them to the digital sign. The present invention pertains to one that can function with a standard Smartphone or tablet device, wherein a software application can be utilized to communicate messages and symbols to the display.

The present invention comprises a wireless display system and a device for personalization of vehicles. It is submitted that the system and device substantially diverge in elements from the prior art, and consequently it is clear that there is a need in the art for an improvement to existing digital vanity display devices. In this regard the instant invention substantially fulfills these needs.

### SUMMARY OF THE INVENTION

In view of the foregoing disadvantages inherent in the known types of digital displays and vehicle communication devices now present in the prior art, the present invention provides a new digital vanity display that can be utilized for providing convenience for the user when personalizing a vehicle, communicating with nearby motorists, and displaying an updatable message from a vehicle using a wireless communication device.

It is therefore an object of the present invention to provide a new and improved digital vanity display system and device that has all of the advantages of the prior art and none of the disadvantages.

It is another object of the present invention to provide a digital vanity display to provide a motorist with an outward message that can be readily updated based on user input on a wireless device paired to the digital display, wherein the sign can display personalized message, warnings, or images that the motorist finds desirable.

Another object of the present invention is to provide a digital vanity display that is readily connectable to the interior or exterior of a vehicle, wherein no hardwired connection is necessary for power or control of the device.

Yet another object of the present invention is to provide a digital vanity display that includes a digital screen having an antiglare coating thereon to improve clarity of the screen in outdoor spaces where glare and bright sunlight may otherwise make the screen difficult to read.

Another object of the present invention is to provide a digital vanity display that can serve multiple purposes for the user, including personalization of the vehicle in the form of a vanity display or digital bumper sticker, as a vehicle communication means between nearby motorists, and as a vehicle warning light for notifying others of an emergency situation or traffic situation.

A final object of the present invention is to provide a digital vanity display that is relatively inexpensive to produce and readily deployed, whereby the device can be enjoyed by motorists of all type for nearby motorist communication and personalization purposes.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the digital vanity display of the present invention.

FIG. 2 shows several embodiments of the display attachment means to a vehicle.

FIG. 3 shows a view of the display in a working state, attached to the rear bumper of a vehicle.

FIG. 4 shows a system diagram of the display in which the display can be manipulated by way of a wireless communications device.

FIG. 5 shows a pictorial representation of a wireless connection between the sign and a handheld wireless communications device.

### DETAILED DESCRIPTION OF THE INVENTION

Reference is made herein to the attached drawings. Like reference numerals are used throughout the drawings to depict like or similar elements of the vehicular digital vanity display. For the purposes of presenting a brief and clear description of the present invention, the preferred embodiment will be discussed as used for personalizing a motor vehicle and communicating with nearby motorists using a wirelessly updatable digital display attached to the vehicle. The figures are intended for representative purposes only and should not be considered to be limiting in any respect.

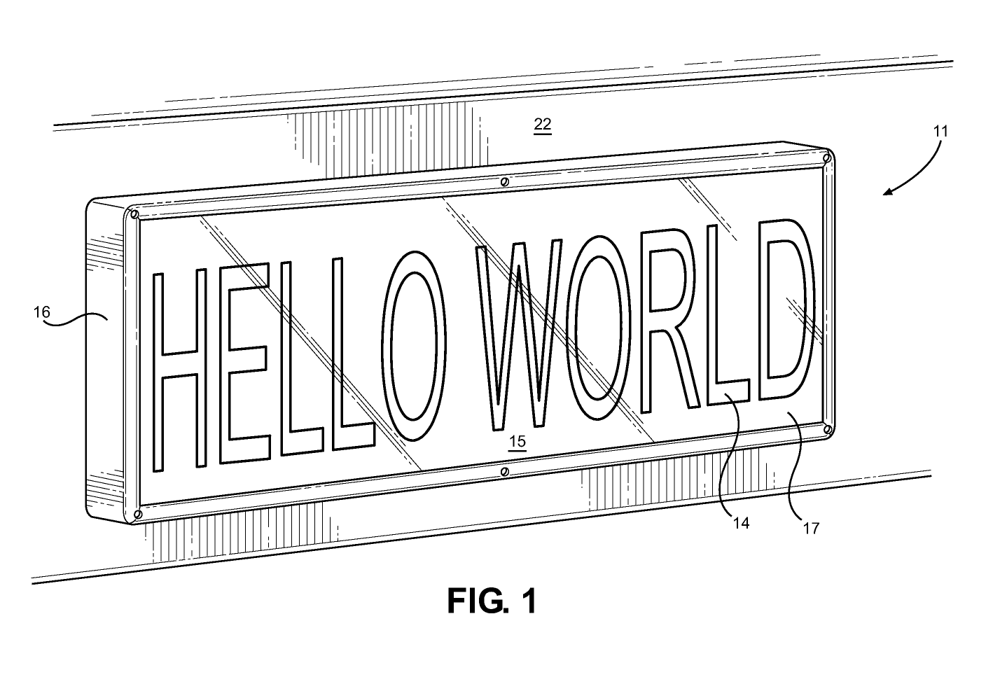

Referring now to FIG. 1, there is shown a frontal perspective view of the digital vanity display device 11 of the present invention in a working state, positioned along the bumper 22 of a vehicle. The device comprises a display 12 mounted along the forward surface of a housing. The housing includes a depth 16 and dimensions that largely match the display area 12. The display 12 itself is an LED or similar digital display that is comprised of a plurality of pixels for forming a visible message 14, symbol, or image for others to visualize.

The device 11 is adapted ideally for exterior use on a motor vehicle, wherein the device functions as a digital sign, bumper sticker, or vanity display for passersby and other motorists to see. The display outer surface 15 is comprised of an antiglare material covering that prevents the message 14 from being blocked or difficult to read in outdoors areas of high sunlight. The antiglare material is an antireflective coating that is applied over the display to reduce reflection from light sources projected thereon. This improves clarity of the display and reduces reflection of light therefrom. The display 12 may comprise pixels of high density to form more intricate and more detailed display objects, or alternatively the display may comprise a simple digital LED screen having the ability to display an alphanumeric message therefrom.

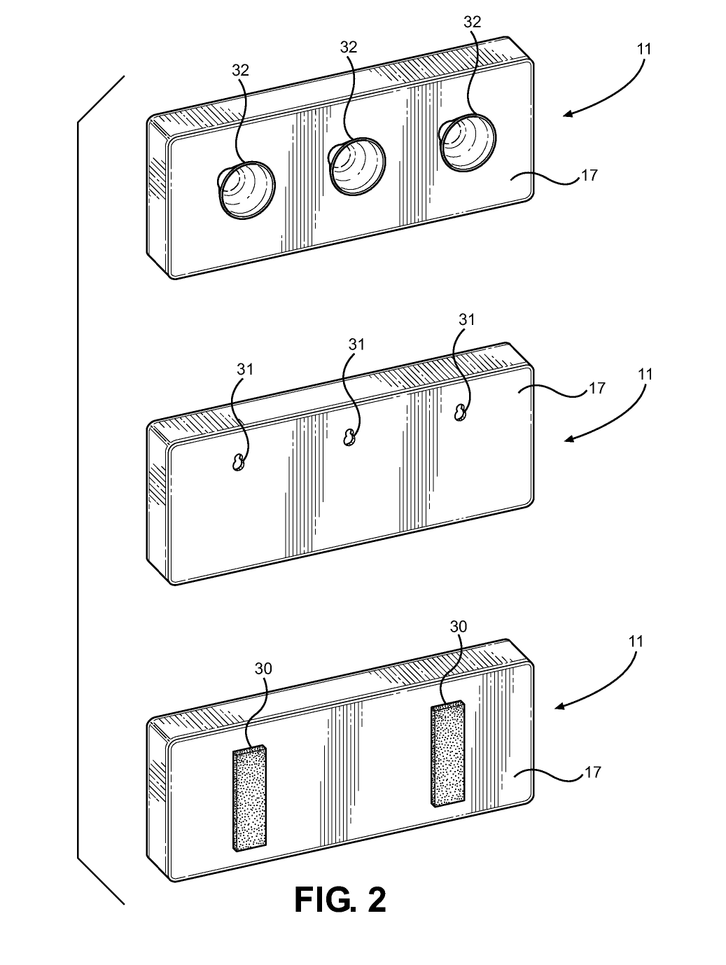

Referring now to FIG. 2, there are shown several embodiments in which are contemplated for attaching the display device 11 to the exterior of a motor vehicle. The exterior of a motor vehicle comprises multiple different surface types, wherein the material and surface contours change depending the given location on the vehicle. To account for this, the device 11 may be connected thereto using several common connectors, including suction cups 32, mechanical fasteners 31, or magnets 30. For external use, these connectors are secured to the backside 17 of the device 11. For internal use, such as against a back window or side window, suction cups may be placed along the forward surface of the device 11 such that the display is projected outward through the window.

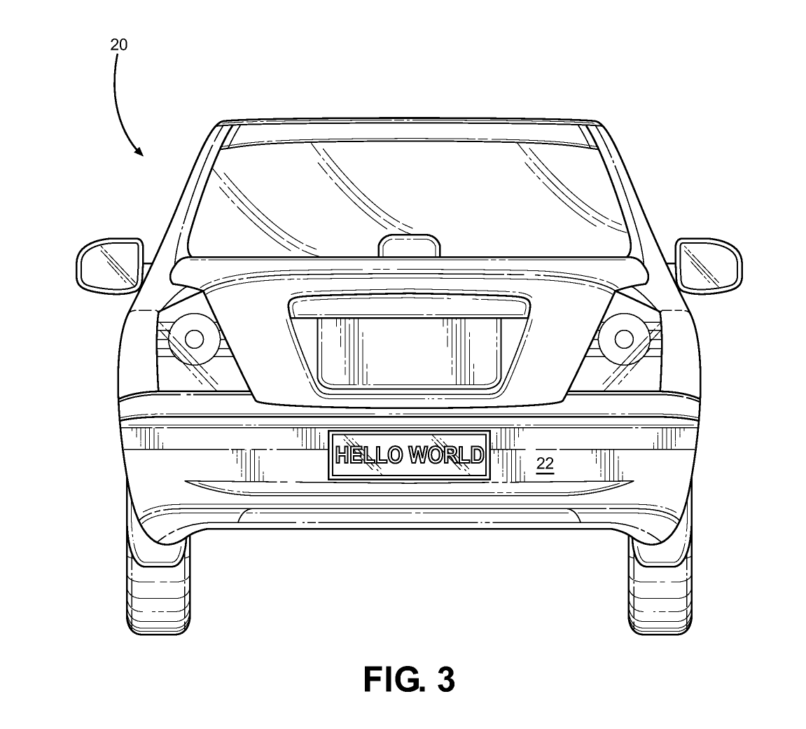

Referring now to FIG. 3, there is shown a view of the display device 11 in a working state, positioned along the rear bumper 22 of a motor vehicle 20 for use in signaling other motorists or for displaying a desired message. The device secures to the bumper using either the magnet, suction cup, or mechanical fastener connection means, while the message on the display can be updated using a wireless signal sent from a user within the vehicle. In this way, the display is updatable to the user's changing preferences and can be changed based on his or her wireless input.

The display device 11 is self-contained and requires no external, hardwired connection in order to remain powered or to communicate with its operator. The device ideally includes a battery pack as a means of power, whereby a processing unit within the device and the display draw power from the battery pack while a wireless antenna receives signals from a handheld device in the possession of the user. Therefore, mounting the device requires the user merely to select a location along the vehicle 20 and secure the device 11 thereto. Operation can be initiated by a power switch, while the battery pack can be easily accessed and replaced periodically. As an alternate embodiment, the device may include a hardwired power connector or leads therefor, wherein power can be derived from the vehicle electrical system. This alternative requires installation (if mounted externally) or a dedicated power outlet (if mounted within the vehicle interior). However, this also eliminates the need for periodic maintenance of the power source.

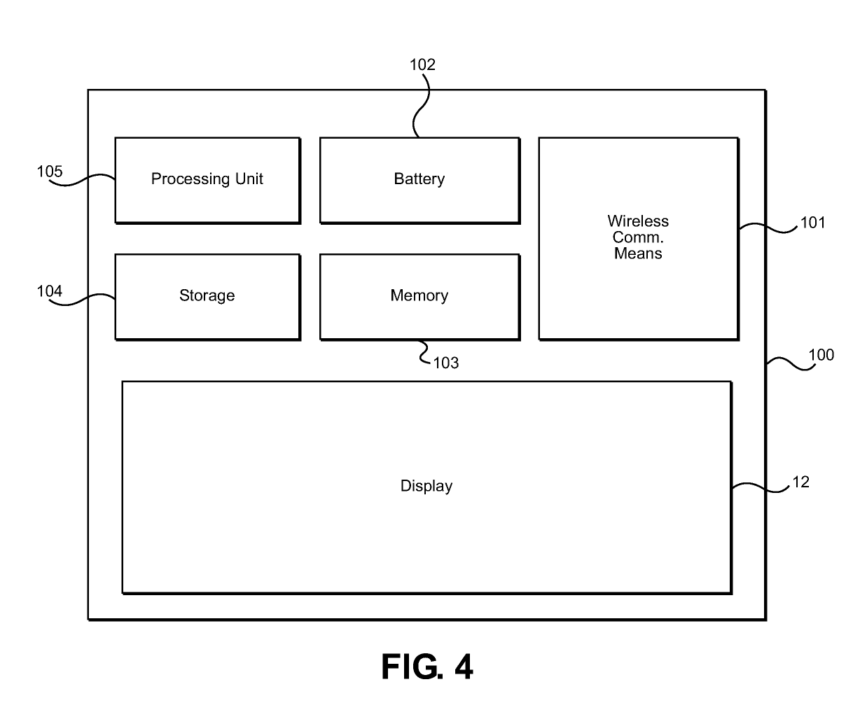

Referring now to FIG. 4, the system 100 and system elements housed within the display device are shown. The device is an independently mounted and wirelessly connected digital device that accepts wireless signals from a user controlling the operation thereof while deployed. The heart of the system 100 is a processing unit 105, such as a CPU, logic circuit, or similar processing means that accepts signals from the various components and directs their operation. A wireless communications means 101 is also provided, which includes an antenna that operates on a given frequency and accepts signals from an operator's wireless handheld device. Preferably, the wireless communication means comprises a Bluetooth connection that is paired with a Smartphone or tablet; however alternate wireless communication frequencies and types of wireless communication is contemplated.

Onboard computer storage 104 provides storage of digital information received from the user and for the operating software of the device. Computer memory 103 stores temporary data during operation of the device and functions in conjunction with the processing unit 105 and the computer storage 104. Finally, a power supply 102 is provided to power the system, which is preferably an onboard battery pack. As previously noted, an external power source may be substituted for the battery pack 102 to provide a more continuous power source that requires less user interaction as it relates to power maintenance.

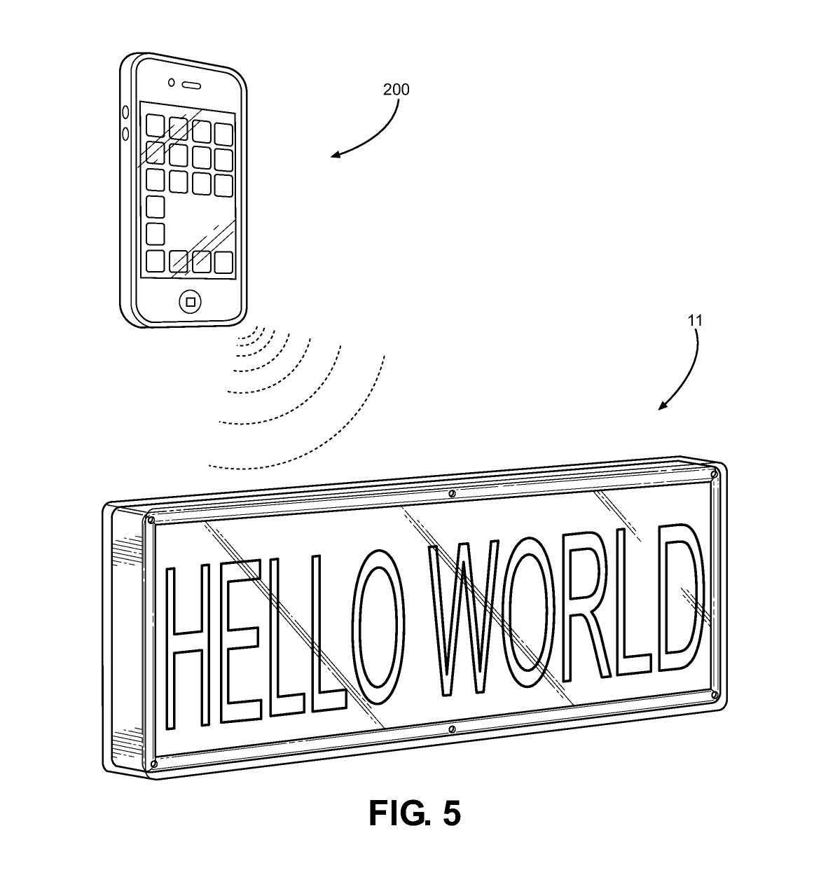

Referring now to FIG. 5, there is shown a pictorial view of the operation of the present invention, wherein a handheld wireless device 200 is utilized to communicate to the digital display device 11 for creating a unique and personalized message that can be projected from a vehicle. The wireless device 200 is preferably a Smartphone device or tablet with Bluetooth or similar wireless connectivity, wherein the handheld device 200 can be paired with the display device 11 for direct communication therewith. To encourage reduced usage of handheld devices during vehicle operation, the display can also communicate with any Bluetooth enabled onboard vehicle computer such as those used in heads up displays, dash mounted entertainment systems and the like. In this manner, the user can simply interact with the dashboard display, inputting text or selecting display options. Software facilitating wireless signal transmission to the display is easily installed on the wireless communication device onboard computer and will include a simple user interface that presents display options and text input functionality to users. The user simply selects the desired option and presses a submit button to affect changes on the vehicle mounted display.

People are always looking for fun, new ways to express themselves. Some may attach bumper stickers to their vehicles for the purposes of personalization of the vehicle and for voicing a message to the public. However these are static messages that require physical removal and replacement to update the message. Still others may place various signs in their vehicle's windows. These can be difficult for other drivers to read. Therefore a fun, new way to express thoughts, ideas, likes, and dislikes is necessary.

The present invention pertains to a digital bumper sticker or vanity display for a vehicle, whereby the display can be readily updated through the use of wireless communication. The device functions as a personalization device and a general vehicular messaging device. The device is ideally suited for external connection to the vehicle; however the device can also be attached to the interior windows for a more secure attachment that will prevent theft thereof. The device is independently mounted, requiring no hardwired connection, whereby the user can deploy a handheld wireless device to update the sign message or control its operation. Overall, the device provides a readily updateable messaging system and means of personalization for a vehicle using a digital display.

It is submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A wirelessly controlled vehicle mounted message system, comprising:
a vehicle display comprising;
a housing having an interior, a backside surface, and a frontside display surface;
a processing unit, a wireless communications means, computer storage, computer memory, and a power supply within said interior of said housing;
said frontside display surface comprising a digital display having an antiglare surface;
a vehicle attachment means adapted to removably secure to a vehicle surface;
a separate computing device having a display, an input means, an antenna, and being enabled for wireless communication with said vehicle display.

2) The system of claim 1, wherein said attachment means is secured to said housing backside surface.

3) The system of claim 1, wherein said attachment means further comprises at least one suction cup.

4) The system of claim 1, wherein said attachment means further comprises at least one magnet.

5) The system of claim 1, wherein said attachment means further comprises at least one mechanical fastener.

6) The system of claim 1, wherein said attachment means further comprises at least one suction cup secured to said housing frontside surface.

7) The system of claim 1, wherein said computing device is a cellular phone.

8) The system of claim 1, wherein aid computing device is a tablet computer.

9) The system of claim 1, wherein said computing device is an onboard vehicle computer.

10) The system of claim 9, wherein said onboard vehicle computer display is mounted within a vehicle dashboard.
